(19) United States
(12) Patent Application Publication
(10) Pub. No.: US 2018/0352354 A1
(43) Pub. Date: Dec. 6, 2018

(54) APPARATUS AND METHOD FOR INTEGRATION OF ENVIRONMENTAL EVENT INFORMATION FOR MULTIMEDIA PLAYBACK ADAPTIVE CONTROL

(71) Applicant: THOMSON Licensing, Issy-les-Mounlineaux (FR)

(72) Inventors: Jaideep CHANDRASHEKAR, San Francisco, CA (US); Azin ASHKAN, San Jose, CA (US); Marc JOYE, Palo Alto, CA (US); Akshay PUSHPARAJA, Mountain View, CA (US); Swayambhoo JAIN, Sunnyvale, CA (US); Shi ZHI, Urbana, IL (US); Junyang QIAN, Stanford, CA (US); Alvita TRAN, Pasadena, CA (US)

(21) Appl. No.: 15/777,192

(22) PCT Filed: Nov. 17, 2015
(86) PCT No.: PCT/US2015/061104

§ 371 Date: May 17, 2018

(51) Int. Cl. H04R 29/00; G06F 3/16

(52) U.S. Cl. CPC H04R 29/001; G06F 3/167; H04R 2227/001; H04R 2430/01; G06F 3/165

(57) ABSTRACT

The present principles generally relate to detection and analysis of sound events in a user's environment to automate changes to a multi-media player's state or action. The multimedia player characterizes ambient sound that it receives. The state or the action of the multimedia player is adaptively initiated or changed according to the characterization of the ambient sound and the location of the player, thus allowing adaptive adjustment of the sound of the audio/video content.

### FIELD OF THE INVENTION

The present principles generally relate to multimedia processing and viewing, and particularly, to apparatuses and methods for detection and analysis of sound events in a user's environment to automate changes to the multimedia player's state or action.

### BACKGROUND

Some cars such as selected models of Prius and Lexus have an adaptive volume control feature for their automobile sound systems. The adaptive volume control feature acts in such a way that when the cars go over a certain speed limit (e.g., 50 miles per hour) the volume of their sound systems will increase automatically to compensate for the anticipated road noise. It is believed, however, that these sound systems adjust the volume based only on the speed data provided by a speedometer and do not adjust the sound levels based on ambient noise detected by an ambient sound sensor.

On the other hand, U.S. Pat. No. 8,306,235, entitled “Method and Apparatus for Using a Sound Sensor to Adjust the Audio Output for a Device,” assigned to Apple Inc., describes an apparatus for adjusting the sound level of an electronic device based on the ambient sound detected by a sound sensor. For example, the sound adjustment may be made to the device's audio output in order to achieve a specified signal-to-noise ratio based on the ambient sound surrounding the device detected by the sound sensor.

### SUMMARY

The present principles recognize that the current adaptive volume control systems described above do not take into consideration the total context of the environment in which the device is being operated. The lack of consideration of the total context is a significant problem because in some environments, enhancing the ability of the user to attend to certain events having a certain ambient sound is more appropriate than drowning out the ambient sound altogether. That is, in certain environments, it may be more appropriate to lower (instead of increase, as in the case of existing systems) the volume of the content being played, such as, e.g., when an ambient sound is an emergency siren or a baby's cry. Therefore, the present principles combine data on ambient sound detected from an ambient sound sensor with the addition of sound identification and location detection in order to dynamically adapt multimedia playback and notification delivery in accordance with the user's local environment and/or safety considerations.

Accordingly, an apparatus is presented, comprising: an audio sensor configured to receive an ambient audio signal; a location sensor configured to determine a location of the apparatus; a processor configured to perform a characterization of the received ambient audio signal; and the processor further configured to initiate an action of the apparatus based on the determined location of the apparatus by the location sensor and the characterization of the received ambient audio signal.

In another exemplary embodiment, a method performed by an apparatus is presented, comprising: receiving via an audio sensor an ambient audio signal; determining via a location sensor a location of the apparatus; performing a characterization of the received ambient audio signal; and initiating an action of the apparatus based on the determined location of the apparatus by the location sensor and the characterization of the received ambient audio signal.

In another exemplary embodiment, a computer program product stored in non-transitory computer-readable storage media, comprising computer-executable instructions for: receiving via an audio sensor an ambient audio signal for an apparatus; determining via a location sensor a location of the apparatus; performing a characterization of the received ambient audio signal; and initiating an action of the apparatus based on the determined location of the apparatus by the location sensor and the characterization of the received ambient audio signal.

### DETAILED DESCRIPTION OF THE DRAWINGS

The above-mentioned and other features and advantages of the present principles, and the manner of attaining them, will become more apparent and the present principles will be better understood by reference to the following description of embodiments of the present principles taken in conjunction with the accompanying drawings, wherein:

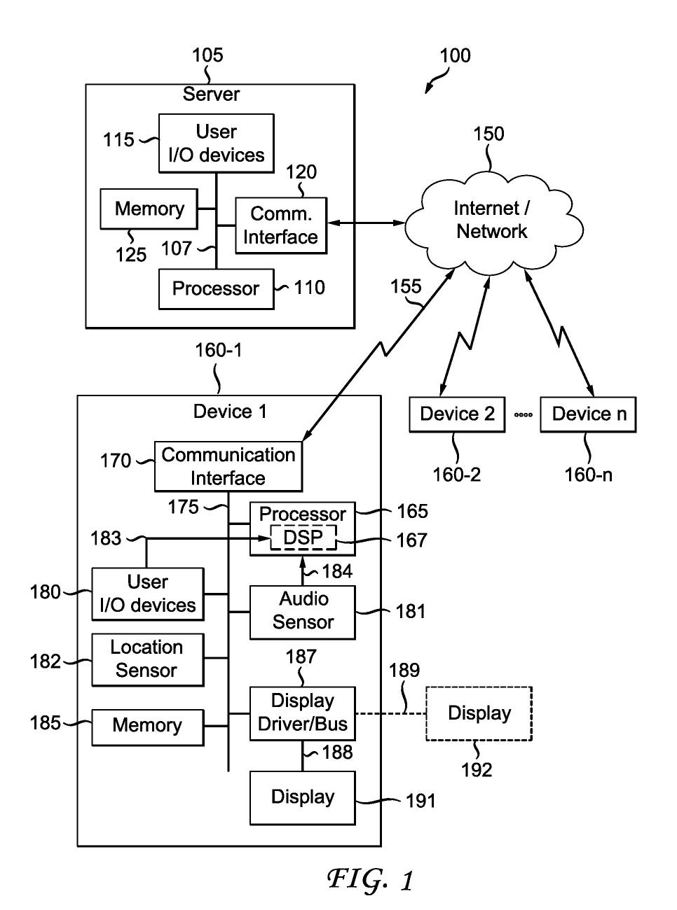

FIG. 1 shows an exemplary system according to an embodiment of the present principles;

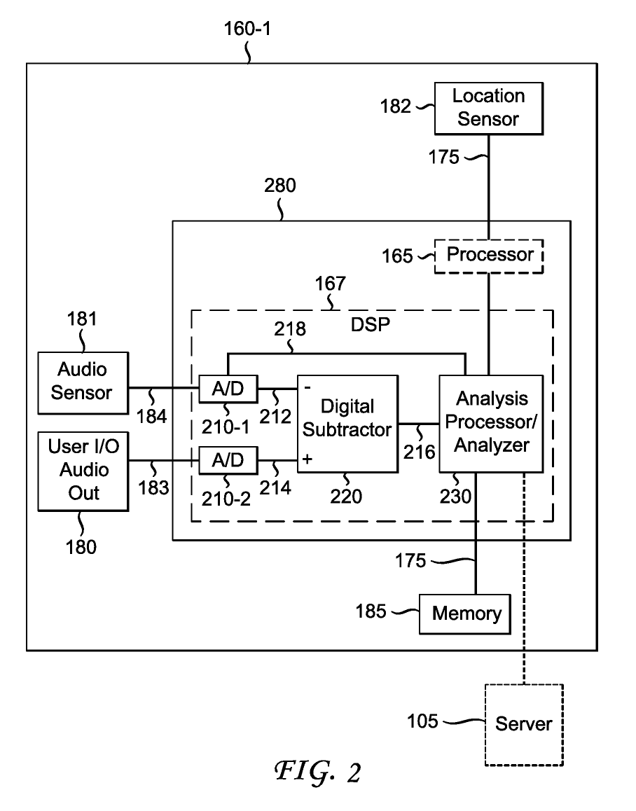

FIG. 2 shows an exemplary apparatus according to an embodiment of the present principles; and

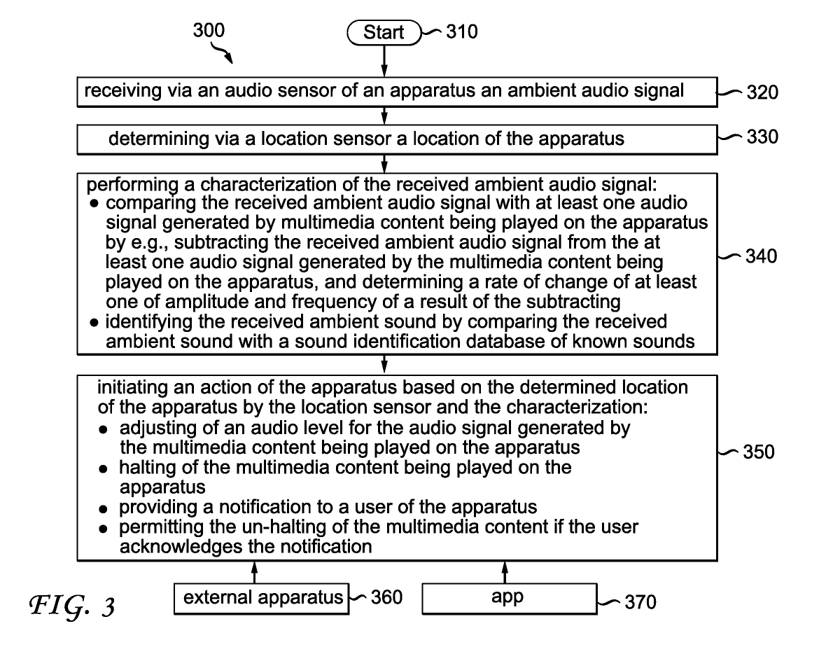

FIG. 3 shows an exemplary process according to an embodiment of the present principles.

The examples set out herein illustrate exemplary embodiments of the present principles. Such examples are not to be construed as limiting the scope of the present principles in any manner.

### DETAILED DESCRIPTION

The present principles recognize that for users consuming contents from, e.g., video on demand (VoD) services such as Netflix, Amazon, or MGO, excessive background noise may interfere with the viewing of multimedia content such as streaming video. This is true for people using VoD applications in different environmental contexts, e.g., at home when other household members are present, on a bus or train commuting, or in a public library.

The present principles further recognize that different ambient sounds may have different importance or significance to a user of multimedia content. For example, although sounds from household appliances, sounds of traffic, or chatter of other passengers in public may interfere with the watching of the user content, these ambient sounds are relatively unimportant and do not represent a specific event of significance which the user may need to pay attention to. On the other hand, ambient sounds such as a baby's cry, a kitchen timer, an announcement of a transit stop, or an emergency siren may have specific significance for which the user cannot afford to miss.

Accordingly, the present principles provide apparatuses and methods to characterize an ambience sound based on input from an ambience sound sensor as well as location information provided by a location sensor such as a GPS, a Wi-Fi connection-based location detector and/or an accelerometer and the like. Therefore, the present principles determine an appropriate action for the user's situation based on the user's location as well as the characterization of the ambient noise. Accordingly, an exemplary embodiment of the present principles can be comprised of 1) sensors for detecting ambient noise and location; 2) an ambient sound analyzer and/or process for analyzing the ambient noise to characterize and identify the ambient sound; and 3) a component or components for adaptively controlling actions of the multimedia apparatus.

The present principles therefore can be employed by a multimedia apparatus for receiving streaming video and/or other types of multimedia content playback. In an exemplary embodiment, the multimedia apparatus can comprise an ambient sound sensor such as a microphone or the like to provide data on the auditory stimuli in the environment. The ambient sound provided by the ambient sound sensor is analyzed by an ambient sound processor/analyzer to provide a characterization of the ambient sound. In one embodiment, the ambient sound detected is compared with a sound identification database of known sounds so that the ambient sound may be identified. In another exemplary embodiment, the sound algorithm/analyzer compares the ambient sound to the audio component of the multimedia content. Accordingly, the sound processor/analyzer continuously characterizes the ambient sound changes in the environment. The processor and/or analyzer maximizes e.g., both the user's experience of the video content and the user's safety by characterizing the noise events as significant or not significant.

In one exemplary embodiment, a processor/analyzer first subtracts the audio component of the multimedia content by the ambient audio signal provided by the ambient audio sensor in the frequency and/or amplitude domain. The processor/analyzer then determines the rate of change of the subtraction result. If the rate of change is constant or small over a period of time, it can be inferred that there is background activity or conversation that the user can tune out. On the other hand, if the rate of change is high, of frequency and/or amplitude, it is more likely that the result marks a specific event that may require user's attention.

In another exemplary embodiment, the received ambient sound is compared with a sound identification database of known sounds to identify the received ambient sound. The sound identification can also include voice recognition so that spoken words in the environment can be recognized and their meaning identified.

In accordance with the present principles, along with ambient signal characterization, the processor/analyzer also considers device information for location context. For example, if a user is watching multimedia content at home as indicated by a GPS sensor, WiFi locating sensor, etc., the processor/analyzer can assign a higher probability of being a significant event to a characterization signal with an abrupt change since this characterization may indicate e.g., young children who are crying or calling out at home, etc. On the other hand, while a user is indicated as being at locations of railroads or subways, the processor/analyzer an assign a lower probability to such events because they could occur due to other unrelated passengers on the public transit system.

Accordingly, if an ambient sound event is characterized as not significant, the volume of the multimedia device can be raised to improve the user's comprehension, and consequently enjoyment of the video in the environment with the interfering ambient sound. On the other hand, if an event is characterized as significant, the multimedia content can be lowered in volume, paused, and/or a notification delivered to the user. In an exemplary embodiment, the content may not be resumed until the user has affirmatively acknowledged the notification, in order to bring the significant off-screen event into the foreground. In another exemplary embodiment, the apparatus can provide for an integration of different software applications and devices that are pre-defined by the user as delivering significant events, such as, for example, connected home devices such as baby monitors or Nest smoke alarms which can directly communicate with the multimedia content playing apparatus. These applications and external devices can activate the notification and/or pausing of the multimedia content playback to signify to the users the sound events are significant and require the immediate attention of the users.

The present description illustrates the present principles. It will thus be appreciated that those skilled in the art will be able to devise various arrangements that, although not explicitly described or shown herein, embody the present principles and are included within its scope.

All examples and conditional language recited herein are intended for pedagogical purposes to aid the reader in understanding the present principles and the concepts contributed to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures can be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment,” “an embodiment” or “an exemplary embodiment” of the present principles, or as well as other variations thereof, means that a particular feature, structure, characteristic, and so forth described in connection with the embodiment is included in at least one embodiment of the present principles. Thus, the appearances of the phrase “in one embodiment,” “in an embodiment,” “in an exemplary embodiment,” or as well any other variations, appearing in various places throughout the specification are not necessarily all referring to the same embodiment.

It is to be appreciated that the use of any of the following “/,” “and/or,” and “at least one of,” for example, in the cases of “A/B,” “A and/or B” and “at least one of A and B,” is intended to encompass the selection of the first listed option (A) only, or the selection of the second listed option (B) only, or the selection of both options (A and B). As a further example, in the cases of “A, B and/or C” and “at least one of A, B and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

FIG. 1 shows an exemplary system according to the present principles. For example, a system 100 in FIG. 1 includes a server 105 which is capable of receiving and processing user requests from one or more of user devices 160-1 to 160-n. The server 105, in response to the user requests, provides program contents comprising various multimedia content assets such as movies or TV shows for viewing, streaming and/or downloading by users using the devices 160-1 to 160-n.

Various exemplary user devices 160-1 to 160-n in FIG. 1 can communicate with the exemplary server 105 over a communication network 150 such as the Internet, a wide area network (WAN) and/or a local area network (LAN). Server 105 can communicate with user devices 160-1 to 160-n in order to provide and/or receive relevant information such as metadata, web pages and media contents, etc., to and/or from user devices 160-1 to 160-n. Server 105 can also provide additional processing of information and data when the processing is not available and/or capable of being conducted on the local user devices 160-1 to 160-n. As an example, server 105 can be a computer having a processor 110 such as, e.g., an Intel processor, running an appropriate operating system such as, e.g., Windows 2008 R2, Windows Server 2012 R2, Linux operating system, etc.

User devices 160-1 to 160-n shown in FIG. 1 can be one or more of, e.g., a personal computer (PC), a laptop, a tablet, a cellphone or a video receiver. Examples of such devices can be, e.g., a Microsoft Windows 10 computer/tablet, an Android phone/tablet, an Apple IOS phone/tablet, a television receiver or the like. A detailed block diagram of an exemplary user device according to the present principles is illustrated in block 160-1 of FIG. 1 as Device 1 and will be further described below.

An exemplary user device 160-1 in FIG. 1 comprises a processor 165 for processing various data and for controlling various functions and components of the device 160-1, including video encoding/decoding and processing capabilities in order to play, display and/or transport multimedia content. The processor 165 communicates with and controls the various functions and components of the device 160-1 via a control bus 175 as shown in FIG. 1.

Device 160-1 can also comprise a display 191 which is driven by a display driver/bus component 187 under the control of processor 165 via a display bus 188 as shown in FIG. 1. The display 191 may be a touch display. In addition, the type of the display 191 may be, e.g., LCD (Liquid Crystal Display), LED (Light Emitting Diode), OLED (Organic Light Emitting Diode), etc. In addition, an exemplary user device 160-1 according to the present principles can have its display outside of the user device or that an additional or a different external display can be used to display the content provided by the display driver/bus component 187. This is illustrated, e.g., by an external display 192 which is connected to an external display connection 189 of device 160-1 of FIG. 1.

In additional, exemplary device 160-1 in FIG. 1 can also comprise user input/output (I/O) devices 180. The user interface devices 180 of the exemplary device 160-1 may represent e.g., a mouse, touch screen capabilities of a display (e.g., display 191 and/or 192), a touch and/or a physical keyboard for inputting user data. The user interface devices 180 of the exemplary device 160-1 can also comprise a speaker or speakers and/or other indicator devices, for outputting visual and/or audio sound, user data and feedback.

Exemplary device 160-1 also comprises a memory 185 which can represent both a transitory memory such as RAM, and a non-transitory memory such as a ROM, a hard drive and/or a flash memory, for processing and storing different files and information as necessary, including computer program products and software (e.g., as represented by a flow chart diagram of FIG. 3 to be discussed below), webpages, user interface information, databases, and etc., as needed. In addition, Device 160-1 also comprises a communication interface 170 for connecting and communicating to/from server 105 and/or other devices, via, e.g., the network 150 using the link 155 representing, e.g., a connection through a cable network, a FIOS network, a Wi-Fi network, and/or a cellphone network (e.g., 3G, 4G, LTE), and etc.

According to the present principles, exemplary device 160-1 in FIG. 1 also comprises an ambient sound audio sensor 181 such as a microphone for detecting and receiving ambient sound or noise in the environment and surroundings of the device 160-1. As shown in FIG. 1, an output 184 of an audio sensor 181 is connected to an input of the processor 165. In addition, an audio output 183 from an audio processing circuitries (not shown) of the exemplary device 160-1 is also connected to an input of processor 165. The audio output can be, e.g., an external audio out output from the audio speakers of device 160-1 when a multimedia content is being played, as represented by output 183 of the user I/O devices block 180. In one exemplary embodiment, both the output 184 of the audio sensor 181 and the audio out output 183 of the exemplary device 160-1 are connected to a digital signal processor (DSP) 167 in order to characterize the ambient sound as to be described further below in connection with the drawing of FIG. 2.

In addition, the exemplary user device 160-1 comprises a location sensor 182 configured to determine the location of the user device 160-1 as shown in FIG. 1. As already described above, a location sensor 182 can be a GPS sensor, a Wi-Fi connection-based location detector and/or an accelerometer, etc., as well known in the art, so that the location of the user device 160-1 can be determined. The location information can be communicated to the processor 165 via the processor communication bus 175 as shown in FIG. 1.

User devices 160-1 to 160-n in FIG. 1 can access different media assets, web pages, services or databases provided by server 105 using, e.g., HTTP protocol. A well-known web server software application which can be run by server 105 to provide web pages is Apache HTTP Server software available from http://www.apache.org. Likewise, examples of well-known media server software applications include Adobe Media Server and Apple HTTP Live Streaming (HLS) Server. Using media server software as mentioned above and/or other open or proprietary server software, server 105 can provide media content services similar to, e.g., Amazon.com, Netflix, or M-GO. Server 105 can use a streaming protocol such as e.g., Apple HTTP Live Streaming (HLS) protocol, Adobe Real-Time Messaging Protocol (RTMP), Microsoft Silverlight Smooth Streaming Transport Protocol, etc., to transmit various programs comprising various multimedia assets such as, e.g., movies, TV shows, software, games, electronic books, electronic magazines, and etc., to an end-user device 160-1 for purchase and/or viewing via streaming, downloading, receiving or the like.

Web and content server 105 of FIG. 1 comprises a processor 110 which controls the various functions and components of the server 105 via a control bus 107 as shown in FIG. 1. In addition, a server administrator can interact with and configure server 105 to run different applications using different user input/output (I/O) devices 115 (e.g., a keyboard and/or a display) as well known in the art. Server 105 also comprises a memory 125 which can represent both a transitory memory such as RAM, and a non-transitory memory such as a ROM, a hard drive and/or a flash memory, for processing and storing different files and information as necessary, including computer program products and software, webpages, user interface information, user profiles, metadata, electronic program listing information, databases, search engine software, etc., as needed. A search engine can be stored in the non-transitory memory 125 of sever 105 as necessary, so that media recommendations can be made, e.g., in response to a user's profile of disinterest and/or interest in certain media assets, and/or criteria that a user specifies using textual input (e.g., queries using “sports,” “adventure,” “Tom Cruise,” etc.). In addition, a database of known sounds can also be stored in the non-transitory memory 125 of sever 105 for characterization and identification of an ambient sound as described further below.

In addition, server 105 is connected to network 150 through a communication interface 120 for communicating with other servers or web sites (not shown) and one or more user devices 160-1 to 160-n, as shown in FIG. 1. The communication interface 120 can also represent television signal modulator and RF transmitter (not shown) in the case when the content provider represents a television station, cable or satellite television provider. In addition, one skilled in the art would readily appreciate that other well-known server components, such as, e.g., power supplies, cooling fans, etc., may also be needed, but are not shown in FIG. 1 to simplify the drawing.

FIG. 2 provides further detail of an exemplary embodiment of a user device 160-1 shown and described before in connection with FIG. 1. As shown in FIG. 2, an output 184 of the ambient sound audio sensor 181 of device 160-1 is connected to an analog-to-digital (A/D) converter 210-1 of a digital signal processor (DSP) 167. In one exemplary embodiment, the DSP 167 is a separate processor. In other embodiments, the processor 165 of device 160-1 can encompass the function of the DSP 167 as shown in FIG. 1, or that two functions are provided together by one system on chip (SoC) IC as represented by block 280 of FIG. 2. Of course, other combinations or implementations are possible as well known in the art.

In addition, as shown in FIG. 2, an audio output 183 from audio processing circuitries of the exemplary device 160-1 for multimedia content playback is connected to another A/D converter 210-2 of the DSP 167. Again, this output can be an audio out output from audio speakers of device 160-1 as represented by audio output 183 from the user I/O devices block 180 of FIG. 1 and FIG. 2. An output 212 of the A/D converter 210-1 is then connected to a “−” input terminal of a digital subtractor 220. An output 214 of the A/D converter 210-2 is connected to the “+” input terminal of the digital subtractor 220. Accordingly, a subtraction between the A/D converted received ambient audio signal 212 and the A/D converted audio out signal 214 generated by the multimedia content being played on the apparatus 260-1 is performed by the digital subtractor 220. The resultant subtraction output 216 from the digital subtractor 220 is connected to an input of an ambient sound analysis processor and/or analyzer 230 in order to character the ambient sound. The ambient sound is to be characterized as significant which would require a user's attention, or not significant which would not require the user's attention, as to be described further below.

In another embodiment, an output 218 of the A/D converter 210 is fed directly to another input of the sound processor/analyzer 230. In this exemplary embodiment, the sound processor/analyzer 230 is configured to characterize the ambient sound received from the audio sensor 181 by directly identifying the ambient sound. For example, one or more of the sound identification systems and methods described in U.S. Pat. No. 8,918,343, entitled “Sound Identification Systems” and assigned to Audio Analytic Ltd., may be used to characterize and identify the ambient sound.

In one exemplary embodiment, the received sound 218 from the audio sensor 181 is compared with a database of known sounds. For example, such a database can contain sound signatures of a baby's cry, an emergency alarm, a police car siren, etc. In another embodiment, the processor/analyzer 230 can also comprise speech recognition capability such as Google voice recognition or Apple Siri voice recognition so that the spoken words representing, e.g., verbal warnings or station announcements can be recognized by the ambient sound processor/analyzer 230. In one exemplary embodiment, the database containing the known sounds including known voices is stored locally in a database as represented by memory 185 as shown in FIG. 2. In another exemplary embodiment, the database is stored in a remote server 105, also as shown in FIG. 2.

In addition, FIG. 2 shows the exemplary user device 160-1 further comprises a location sensor 182 configured to determine the location of the user device 160-1, as already shown above in connection with FIG. 1. Again, a location sensor 182 can be a GPS sensor, a Wi-Fi connection-based location detector and/or an accelerometer, etc., as well known in the art, so that the location of the user device 160-1 can be determined. The location information from the location sensor 182 can be communicated to the processor 165 via the processor communication bus 175 as shown in FIG. 2 (also as shown in FIG. 1 and already described above).

FIG. 3 represents a flow chart diagram of an exemplary process 300 according to the present principles. Process 300 can be implemented as a computer program product comprising computer executable instructions which can be executed by a processor (e.g., 165, 167 and/or 280) of device 160-1 of FIG. 1 and FIG. 2. The computer program product having the computer-executable instructions can be stored in a non-transitory computer-readable storage media as represented by e.g., memory 185 of FIG. 1 and FIG. 2. One skilled in the art can readily recognize that the exemplary process 300 shown in FIG. 3 can also be implemented using a combination of hardware and software (e.g., a firmware implementation) and/or executed using programmable logic arrays (PLA) or application-specific integrated circuit (ASIC), etc., as already mentioned above.

The exemplary process shown in FIG. 3 starts at step 310. Continuing at step 320, an ambient audio signal is received via an audio sensor 181 of an exemplary apparatus 160-1 shown in FIG. 1 and FIG. 2. At step 330, the location of the exemplary apparatus 260-1 is determined via a location sensor 182 shown in FIG. 1 and FIG. 2.

At step 340, a characterization of the received ambient audio signal is performed. In one exemplary embodiment, the received ambient audio signal is compared with at least one audio signal generated by multimedia content being played on the apparatus. In another embodiment, the comparison is performed by subtracting the received ambient audio signal from the at least one audio signal generated by the multimedia content being played on the apparatus. The characterization signal is formed by determining a rate of change of at least one of amplitude and frequency of the result of the above subtraction. Still at step 340, in another embodiment of performing a characterization of the received ambient sound, the received ambient sound is directly identified by comparing the received ambient sound with a sound identification database of known sounds.

At step 350, an action of the apparatus is initiated based on the determined location of the user device 160-1 provided by the location sensor 182 shown in FIG. 1 and FIG. 2, and the characterization of the ambient sound performed at step 340 as described above. In one exemplary embodiment, the action initiated can be adjusting of an audio level for the audio signal generated by the multimedia content being played on the apparatus. Another action can be halting of the multimedia content being played on the apparatus. In another exemplary embodiment, the action can be to provide a notification to a user of the apparatus, and permitting the un-halting of the multimedia content if the user acknowledges the notification. Accordingly, to the present principles, therefore, if an event is characterized as significant which requires a user's attention, the audio output of the multimedia content can be lowered in volume, paused, and/or a notification delivered.

At step 360, according to another exemplary embodiment of the present principles, an input from an external apparatus such as a fire alarm, a baby monitor, etc., can be received by the exemplary device 160-1 shown in FIG. 1 and FIG. 2. If such an input is received, an exemplary action as described above at step 350 is initiated regardless of the current ambient sound characterization Likewise, at step 370, this override input can be provided by an app associated with the apparatus.

While several embodiments have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present embodiments. More generally, those skilled in the art will readily appreciate that all parameters, dimensions, materials, and configurations described herein are meant to be exemplary and that the actual parameters, dimensions, materials and/or configurations will depend upon the specific application or applications for which the teachings herein is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereof, the embodiments disclosed may be practiced otherwise than as specifically described and claimed. The present embodiments are directed to each individual feature, system, article, material and/or method described herein. In addition, any combination of two or more such features, systems, articles, materials and/or methods, if such features, systems, articles, materials and/or methods are not mutually inconsistent, is included within the scope of the present embodiment.

1. An apparatus, comprising:
an audio sensor configured to receive an ambient audio signal;
a location sensor configured to determine a location of the apparatus;
a processor configured to perform a characterization of the received ambient audio signal; and
the processor further configured to initiate an action of the apparatus based on the determined location of the apparatus by the location sensor and the characterization of the received ambient audio signal.

2. The apparatus of claim 1, wherein the characterization is performed by a comparison of the received ambient audio signal with at least one audio signal generated by multimedia content being played on the apparatus.

3. The apparatus of claim 2, wherein the comparison is performed by a subtraction of the at least one audio signal generated by the multimedia content being played on the apparatus by the received ambient audio signal.

4. The apparatus of claim 3, wherein the characterization is further performed by determining a rate of change of at least one of amplitude and frequency of a result of the subtraction.

5. The apparatus of claim 1 wherein the characterization is performed by comparing the received ambient sound with a sound identification database of known sounds to identify the received ambient sound.

6. The apparatus of claim 1, wherein the action comprises adjusting of an audio level for the audio signal generated by the multimedia content being played on the apparatus.

7. The apparatus of claim 1, wherein the action comprises halting of the multimedia content being played on the apparatus.

8. The apparatus of claim 1, wherein the action comprises providing a notification to a user of the apparatus.

9. The apparatus of claim 7, wherein the action further comprises halting of the multimedia content being played on the apparatus and permitting the un-halting of the multimedia content if the user acknowledges the notification.

10. The apparatus of claim 1 further comprises a communication interface configured to receive an input from an external apparatus and the apparatus initiates the action also in response to the received input from the external apparatus.

11. The apparatus of claim 1 further comprises a software application and wherein the apparatus initiates the action also in response to a received input from the software application.

12. A method performed by an apparatus, comprising:
performing a characterization of a received ambient audio signal; and
initiating an action of the apparatus based on a determined location of the apparatus by the location sensor and the characterization of the received ambient audio signal.

13. The method of claim 12, wherein the performing further comprising comparing the received ambient audio signal with at least one audio signal generated by multimedia content being played on the apparatus.

14. The method of claim 13, wherein the comparing further comprising subtracting the received ambient audio signal from the at least one audio signal generated by the multimedia content being played on the apparatus.

15. The method of claim 14, wherein the performing further comprising determining a rate of change of at least one of amplitude and frequency of a result of the subtracting.

16. The method of claim 12 wherein the performing further comprising identifying the received ambient sound by comparing the received ambient sound with a sound identification database of known sounds.

17. The method of claim 12, wherein the action comprises adjusting of an audio level for the audio signal generated by the multimedia content being played on the apparatus.

18. The method of claim 12, wherein the action comprises halting of the multimedia content being played on the apparatus.

19. The method of claim 12, wherein the action comprises providing a notification to a user of the apparatus.

20. The method of claim 19, wherein the action further comprises halting of the multimedia content being played on the apparatus and permitting the un-halting of the multimedia content if the user acknowledges the notification.

21. The method of claim 12 further comprises receiving an input from an external apparatus and initiating the action also in response to the received input from the external apparatus.

22. The method of claim 12 further comprises initiating the action also in response to a received input from a software application.

23. A computer program product stored in non-transitory computer-readable storage media, comprising computer-executable instructions for:
performing a characterization of a received ambient audio signal; and
initiating an action of the apparatus based on a determined location of the apparatus by the location sensor and the characterization of the received ambient audio signal.
